(19) United States
(12) Patent Application Publication
(10) Pub. No.: US 2023/0256369 A1
(43) Pub. Date: Aug. 17, 2023

(54) LIQUID SEPARATOR

(71) Applicant: CELLCENTRIC GMBH & CO. KG, Kirchheim unter Teck (DE)

(72) Inventors: Michael KIBLER, Beuren (DE); Peter WISSHAK, Baltmannsweiler (DE); Sven SCHMALZRIEDT, Esslingen (DE); Alexander MATHEIS, Plochingen (DE); Tobias STARK, Renningen (DE); Peter BAUMGARTL, Erkheim (DE)

(21) Appl. No.: 18/006,891

(22) PCT Filed: Jul. 26, 2021
(86) PCT No.: PCT/EP2021/070779

§ 371 Date: Jan. 26, 2023

(30) Foreign Application Priority Data
Jul. 27, 2020 (DE) 10 2020 004 533.2

(51) Int. Cl. B01D 45/08; H01M 8/0267; H01M 8/04828

(52) U.S. Cl. CPC B01D 45/08; H01M 8/0267; H01M 8/04843

(57) ABSTRACT

The invention relates to a liquid separator (17) for a gas flow charged with liquid, having an inner volume (21) which has at least one baffle element (23) and a collection area (24) for the separated liquid.

The invention is characterized in that a heat-conducting element (30) made of a material having good heat conductivity is arranged in the collection area (24) and protrudes in the direction of the at least one baffle element (23) into the gas flow (25) in the inner volume (21), wherein the baffle element (23) is made from a material which conducts heat less well than the heat-conducting element (30).

The invention relates to a liquid separator for a gas flow charged with liquid, according to the type defined in more detail in the preamble of claim 1. The invention also relates to the use of such a liquid separator.

Liquid separators or water separators are known in principle from the prior art. These typically have baffle elements at which a gas flow charged with liquid suddenly changes its flow direction, so that the liquid is separated and runs downward on the baffle plates, for example due to gravity. A corresponding example is shown in DE 31 09 240 A1.

Liquid separators are now widely used in fuel cell systems, in which it is important to separate water from the exhaust gases of the fuel cell because this water, which is typically product water of the fuel cell, freezes very easily due to its purity. This can then already result in problems at temperatures around the freezing point, in particular in starting problems of fuel cells, since components and/or flow paths can be blocked by ice. In this context, for example, DE 10 2007 023 417 A1 describes a water separator in which heat-conducting elements connected to electrical heating elements make it possible to heat and thaw the water separator as required.

Although such thawing as needed ensures the functionality of the structure, it is complex in terms of construction and typically causes an additional electrical energy requirement, which has a disadvantageous effect on the overall energy balance of such a system.

The object of the present invention is therefore to specify an improved liquid separator which avoids these disadvantages and which ensures highly efficient operation with a reduced risk of ice formation, at least during operation.

According to the invention, this object is achieved by a liquid separator having the features in claim 1, and here in particular in the characterizing part of claim 1. Advantageous refinements and developments result from the dependent claims. Claim 10 also specifies a particularly preferred use of such a liquid separator.

The liquid separator according to the invention comprises an inner volume having at least one baffle element, as is also the case in the prior art. In addition to the baffle element, a collection area for the separated liquid is arranged in the volume, typically in such a way that this collection area lies below the baffle element in the direction of gravity when used as intended, or is located in its lower area, so that the separated liquid reaches the collection area with the aid of gravity.

According to the invention, it is now provided that a heat-conducting element made of a material with good heat conductivity is arranged in the collection area. In the direction of the baffle element, this protrudes into the gas flow in the volume. The baffle element itself is made from a material that conducts heat less well than the heat-conducting element. This has the result that the liquid is separated at the baffle element, as in a conventional liquid separator. It then drips down, for example following gravity, and drips or flows into a collection area. A heat-conducting element is located in the collection area in contact with the liquid and protrudes out of the collection area in the direction of the gas flow and thus in the direction of the baffle element. The functionality is now that liquid is separated when the flow charged with liquid droplets hits the baffle element and drips down. Due to the rather poor heat conductivity of the baffle element, the liquid that has been separated remains relatively warm. The gas flow, which has largely been freed from its liquid droplets, then flows at least partially along the heat-conducting element and transfers the heat contained therein to the heat-conducting element, which introduces this heat into the collection area and the liquid collected there. Heat is thus transported into the collection area both from the separated liquid droplets and from the heat-conducting element. This collection area can thus already be passively heated very well without external heating or the connection to electrical heating elements, a heat exchanger through which a heating medium flows, or the like, which additionally of course also continue to be possible and conceivable. The solidification of the liquid, for example if it is water, the formation of ice, can thus be largely prevented or, in comparison to the structures from the prior art, at least significantly reduced.

According to an extremely favorable refinement of the concept, it is thereby provided that the heat-conducting element is connected to the baffle element, so that in any case the majority of the gas flow or preferably the entire gas flow comes into contact with the heat-conducting element and can give off heat to the heat-conducting element.

It has been shown that this structure having the heat-conducting element projecting up to the baffle element and the corresponding design having a heat-conducting element having good heat conductivity and a baffle element having poor heat conductivity is particularly favorable with regard to the transfer of heat into the collection area. The connection ensures that largely the entire volume flow of the gas comes into contact with the heat-conducting element. On the other hand, the fact that it is designed differently from the baffle element in terms of its material and its heat conductivity has the effect that the overall length of the heat-conducting element can be made significantly shorter than if it were to also comprise the baffle element. This ensures good heat transfer over a relatively short distance into the collection area. If the baffle element were also made of metal having good heat conductivity, heat that had previously been absorbed and/or had been withdrawn from the liquid droplets would already be released back into the gas flow on the way. The heat input into the collection area, which is the actual goal of the structure, would be significantly worse than in the described structure having a heat-conducting element with good heat conductivity and a baffle element with worse heat conductivity. This is particularly favorable in particular when the elements are designed in accordance with the structure described below.

According to an extraordinarily favorable refinement of the liquid separator according to the invention, it is provided that the heat-conducting element is produced from metal, preferably of a metal alloy having good heat conductivity, for example an aluminum alloy. The baffle element can be made of plastic, which accordingly has a significantly poorer heat conduction than the metal of the heat-conducting element. This allows the advantage described above to be used ideally.

Another very advantageous embodiment of the variant of the liquid separator, in which the heat-conducting element is connected to the baffle element, can also provide for the heat-conducting element to be formed in two parts. It then consists, for example, of a metal sheet, which is arranged in the area of the collection area, and a connection element between this heat-conducting metal sheet and the baffle element. This connection element can be connected to the baffle element, for example, via a plug or clip connection.

Another very favorable embodiment of the liquid separator according to the invention also provides that the heat-conducting element, or at least the connection element according to the embodiment variant just described, has one or more plates, which are smaller in area than the cross section of the volume through which flow can take place. This structure makes it possible to manage with solid plates as heat-conducting elements. These solid plates are then able to absorb a relatively large amount of heat. They are designed in such a way that they take up a large part, but not all, of the cross section for the flow of the gas. The gas then has to flow along these plates, is deflected accordingly, and then flows out of the liquid separator. As a result, an ideal heat input into the plates of the heat-conducting element is achieved on the one hand and on the other hand any residual liquid that is possibly still present in the gas is separated as a result of the renewed deflection of the gas flow as it flows around the plates.

The heat-conducting element or, in the case of the above-mentioned structure, preferably again the connection element of the heat-conducting element can also have a perforated plate, rods, a grid, or the like. On the one hand, these allow an arrangement in the flow of the gas, so that heat can be absorbed thereby, and on the other hand, a corresponding permeability for the gas, so that they can virtually “fill up” the entire cross section, which is correspondingly simple in terms of design and installation and, on the other hand, allow the gas to pass reliably due to the holes, the grid structure, or the distance between the rods, which can also be in the form of crossing rods touching one another at the crossing points.

A further very favorable embodiment of the liquid separator according to the invention can also provide for a housing of the liquid separator around the inner volume and the baffle element being made in one piece. This structure is particularly simple and efficient to produce and assemble. For example, it can provide that both the baffle element and the housing are made of plastic. This can then be constructed, for example, as an injection-molded part that is relatively easy to implement, into which the heat-conducting element, for example in the form of a metal sheet, is clipped or is screwed tightly into this housing in order to fulfill the above-described functionality and preferably to connect the collection area to the baffle element.

Another extraordinarily favorable embodiment of the liquid separator according to the invention can also provide that exactly one baffle element is provided in the inner volume. This structure having only a single baffle element is sufficient for many applications such as separating water in the anode circuit of a fuel cell system with a suitable design and can thus ensure an extremely simple, compact structure that is inexpensive to produce. A further very advantageous variant of the liquid separator according to the invention can additionally provide that the collection area is connected to the environment or to another component via a drain valve. Such a drain valve, especially if it is formed in direct connection to the collection area, and is possibly also integrated or at least thermally connected to the liquid separator and the collection area, has the further advantage that a relatively large, heavy component having a high heat capacity is thereby arranged at the collection area. This can also benefit from heating via the heat-conducting element—to prevent freezing—and helps to store heat in this area to some extent. In addition, it allows the liquid to be drained off in a targeted manner, for example as a function of a fill level which has been measured, calculated from a simulation, or ascertained in a similar manner.

The liquid separator according to the invention can now be implemented and produced in a correspondingly simple and efficient manner. In particular, it is able to ensure operation of a system into which it has been integrated without additional heating even under adverse external conditions, since due to the transfer of heat to the area in which the liquid collects, solidification of this liquid can be largely prevented. This also applies, for example, to water, in particular to ultrapure water, which is already very susceptible to freezing at temperatures around the freezing point. This can be reliably prevented by the structure having the heat-conducting element and the heating of the collection area. The liquid separator according to the invention is therefore particularly suitable as a water separator and here in particular as a water separator in the exhaust gas flow of a fuel cell, in which pure water is produced as the product water of the fuel cell, which is correspondingly susceptible to freezing. For example, if the fuel cell is installed as a fuel cell system in a vehicle in which it supplies electrical power, then situations in which the vehicle is traveling at temperatures below freezing point cannot be ruled out. The liquid separator according to the invention is therefore particularly suitable for such applications, but its application is not restricted thereto.

Further advantageous embodiments of the liquid separator according to the invention and the use thereof result from the exemplary embodiment, which is described in more detail hereinafter with reference to the figures.

Thereby shows:

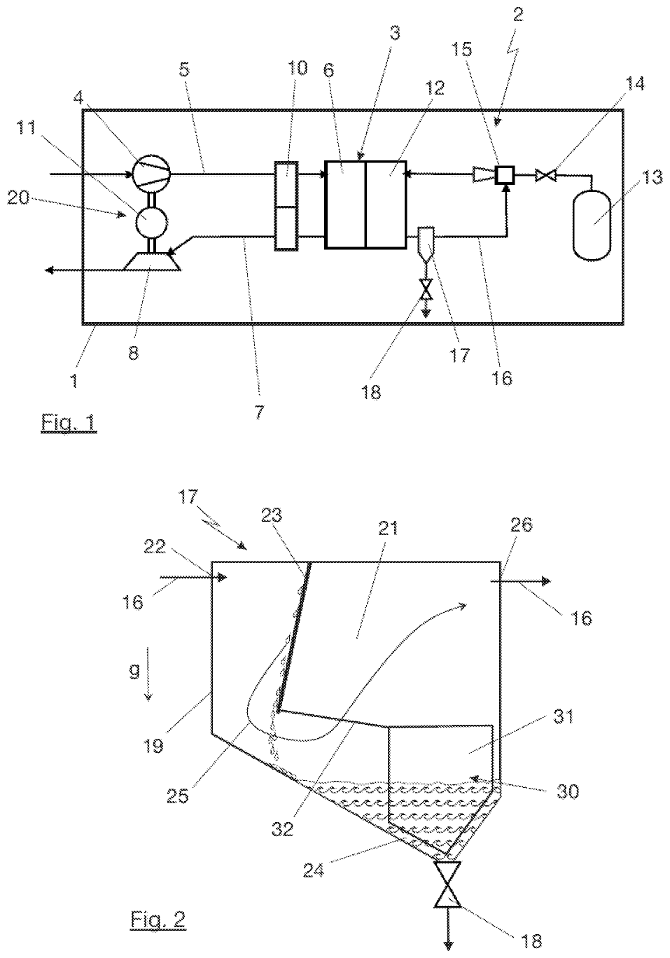

FIG. 1 an exemplary vehicle having a fuel cell system, which has a liquid separator according to the invention as a water separator; and

FIG. 2 a cross section through a possible structure of the liquid separator according to the invention.

In the illustration of FIG. 1, a very schematically indicated vehicle 1 can be seen, which is to have a fuel cell system 2, which is intended to provide electrical power, in particular to provide electrical drive power for the vehicle. The core of the fuel cell system 2 is formed by a fuel cell 3, which is typically designed as a stack of individual cells. The structure is also referred to hereinafter as a fuel cell stack. For example, it can be designed having proton-conducting membranes as the electrolyte, thus it can have so-called PEM fuel cells. The fuel cell stack 3 is supplied on its cathode side 6 with air from an air conveying device 4, for example a flow compressor, which flows via a supply air line 5 and a gas/gas humidifier 10 into the cathode side 6 of the fuel cell stack 3 in the embodiment shown here. Via an exhaust air line 7, the oxygen-depleted air flows in turn through the gas/gas humidifier 10 out of the cathode side 6 of the fuel cell stack 3. Moisture is given off to the supply air in the supply air line 5 via the humidifier 10 in this case. The exhaust air then enters an exhaust air turbine 8, in which it is expanded in order to recover heat energy and pressure energy. An electrical machine 11 is operatively connected to this exhaust air turbine 8 on the one hand and the flow compressor 4 on the other hand. This structure, which is also referred to as an electric turbocharger 20 or motor-assisted turbocharger, is used to efficiently supply air to the fuel cell system 2 and is known from the prior art to the extent that it does not need to be discussed further.

An anode side 12 of the fuel cell stack 3 is supplied with hydrogen from a compressed gas store 13 via a pressure control and metering valve 14. Hydrogen that has not been consumed returns via a recirculation line 16 from the anode side 12 of the fuel cell stack 3 to a gas jet pump 15 as a recirculation conveyor device and is mixed with fresh hydrogen, which is also used as a driving jet for the gas jet pump 15, and supplied back to the anode side 12. Alternatively or additionally to this gas jet pump 15, a recirculation fan could also be provided here. In the recirculation line 16 or in the structure for the recirculation of unconsumed hydrogen, referred to as the anode loop, there is now a liquid separator 17, which is connected to the environment via a drain valve 18 in the exemplary embodiment shown here. A connection, for example, to the exhaust air line 7 before or in particular after the exhaust air turbine 8 would be just as conceivable. All of this is clear enough to a person skilled in the art of fuel cell systems that it does not need to be discussed further. In the following, the liquid separator or water separator 17 in particular will now be described in more detail. In the representation of FIG. 2, its structure is shown schematically in a cross section. The water separator 17, a housing designated by 19, which is to be produced, for example, as an injection molded part made of plastic. The drain valve 18 is in direct contact with the housing 19, which surrounds an inner volume 21. It is now crucial for the functionality of the liquid separator 17 that an inflow opening 22, which is connected upstream to the recirculation line 16, is followed by a baffle element 23, which blocks the entire incident flow cross section for the gas flow charged with liquid from the recirculation line 16. This baffle element 23 can preferably be formed in one piece with the housing 19 and also made of plastic. The flow charged with the liquid droplets, which flows from the recirculation line 16 through the inflow opening 22 into the inner volume 21, therefore impacts against this baffle element 23 and is sharply deflected. The water contained therein collects at the baffle element 23 and, as shown here, drips in the direction of gravity g when the liquid separator 17 is used as intended, downwards and along a part of the housing 19 into a collection area 24, which is arranged therein below the part of the inner volume 21 through which gas flows and which is connected to the drain valve 18. The gas completely or largely freed from the liquid then flows according to the arrow designated by 25 through the inner volume 21 of the liquid separator 17 and through an outflow opening 26 upstream back into the recirculation line 16.

In the collection area 24 and projecting beyond it in the direction of the gas flow according to the arrow 25, a heat-conducting element 30 is now located, which is produced from an aluminum alloy, for example. It consists of a first metal sheet 31, which is at least partially arranged in the collection area 24 and protrudes into the liquid collecting there, which is indicated here by a liquid level. A connection element 32, which is also made of an aluminum alloy and is preferably made in one piece with the metal sheet 31 or is at least connected thereto with very good heat conductivity, for example welded, protrudes in the direction of the baffle element 23 and is preferably mechanically connected thereto, for example clipped, riveted, screwed, adhesively bonded, or the like. In principle, the connection element 32 can be designed as a perforated plate, as a certain number of rods, as a grid, or the like. The structure made up of one or more plates, which largely or not entirely block the flow cross section of the inner volume 21 perpendicular to the plane of the drawing, is also conceivable. In the case of multiple baffle elements 23, multiple connection elements 32 or one connection element 32 connecting them all to one another would accordingly also be conceivable.

The connection element 32 and partially also the plate 31 of the heat-conducting element 30 now absorb heat from the gas flow flowing according to the arrow 25. Together with the heat that remains in the liquid droplets, since the baffle element 23 is made of plastic and therefore has poor heat conductivity, this has the result that heat is introduced into the collection area 24 over relatively short paths of the heat-conducting element 30, in addition to the heat which is already contained in the liquid itself. In operation of the liquid separator or water separator 17, this results in very good heating of the liquid in the collection area 24, so that the risk of ice formation can be avoided or at least minimized.

1. A liquid separator for a gas flow charged with liquid, having an inner volume, which has at least one baffle element and a collection area for the separated liquid,
wherein
a heat-conducting element made of a material with good heat conductivity is arranged in the collection area and protrudes in the direction of the at least one baffle element into the gas flow in the inner volume, wherein the baffle element is made from a material which conducts heat less well than the heat-conducting element.

2. The liquid separator as claimed in claim 1, wherein
the heat-conducting element and the at least one baffle element are connected to one another.

3. The liquid separator as claimed in claim 1, wherein
the heat-conducting element is made of metal and the at least one baffle element is made of plastic.

4. The liquid separator as claimed in claim 2, wherein
the heat-conducting element is made of a metal sheet element and a connection element to the at least one baffle element.

5. The liquid separator as claimed in claim 1,
wherein
the heat-conducting element has one or more plates, which are smaller in area than the cross section of the inner volume through which flow can take place.

6. The liquid separator as claimed in claim 1,
wherein
the heat-conducting element has at least one perforated plate, multiple rods, and/or at least one grid.

7. The liquid separator as claimed in claim 1,
wherein a housing around the inner volume and the at least one baffle element are formed in one piece.

8. The liquid separator as claimed in claim 1,
wherein
exactly one baffle element is provided.

9. The liquid separator as claimed in claim 1,
wherein
the collection area has a drain valve or is connected directly thereto, via which the collection area is switchably connected to the environment or a further component.

10. A use of the liquid separator as claimed in claim 1 as a water separator in an exhaust gas flow of a fuel cell system.

11. The liquid separator as claimed in claim 2, wherein the heat-conducting element is made of metal and the at least one baffle element is made of plastic.

12. The liquid separator as claimed in claim 3, wherein the heat-conducting element is made of a metal sheet element and a connection element to the at least one baffle element.

13. A use of the liquid separator as claimed in claim 2 as a water separator in an exhaust gas flow of a fuel cell system.

14. A use of the liquid separator as claimed in claim 3 as a water separator in an exhaust gas flow of a fuel cell system.

15. A use of the liquid separator as claimed in claim 4 as a water separator in an exhaust gas flow of a fuel cell system.

16. A use of the liquid separator as claimed in claim 5 as a water separator in an exhaust gas flow of a fuel cell system.

17. A use of the liquid separator as claimed in claim 6 as a water separator in an exhaust gas flow of a fuel cell system.

18. A use of the liquid separator as claimed in claim 7 as a water separator in an exhaust gas flow of a fuel cell system.

19. A use of the liquid separator as claimed in claim 8 as a water separator in an exhaust gas flow of a fuel cell system.

20. A use of the liquid separator as claimed in claim 9 as a water separator in an exhaust gas flow of a fuel cell system.
